(19) United States
(12) Patent Application Publication
(10) Pub. No.: US 2024/0321004 A1
(43) Pub. Date: Sep. 26, 2024

(54) METHOD OF MANAGEMENT OF A VISITOR WORKFLOW

(71) Applicant: Konica Minolta Business Solutions U.S.A., Inc., San Mateo, CA (US)

(72) Inventor: Darrell Eugene Bellert, Boulder, CO (US)

(73) Assignee: Konica Minolta Business Solutions U.S.A., Inc., San Mateo, CA (US)

(21) Appl. No.: 18/189,830

(22) Filed: Mar. 24, 2023

(51) Int. Cl. G06V 40/16; G06T 7/20; G06V 10/96; G06V 10/98; G06V 20/52; G06V 40/40

(52) U.S. Cl. CPC G06V 40/172; G06T 7/20; G06V 10/96; G06V 10/993; G06V 20/52; G06V 40/161; G06V 40/45; G06T 2207/10016; G06T 2207/30168; G06T 2207/30201; G06T 2207/30232

(57) ABSTRACT

A method for management of a visitor workflow includes receiving a video stream from a camera and using a first thread and a second thread. The first thread generates one or more expiring buffers by: processing frames of the video stream; using an object recognition algorithm to detect and track each face in the frames of the video stream and assign a universal unique identifier (UUID) for each face; and maintaining, for each UUID, a corresponding expiring buffer that includes a timer and the frames of the video stream showing the face corresponding to the UUID. The second thread processes a given expiring buffer by: allocating frames of the given expiring buffer to a biometric thread pool comprising a biometric subthread for each algorithm of a biometric algorithm list; executing the biometric thread pool in parallel; and determining a workflow based on the biometric results.

### BACKGROUND

Biometric algorithms have become a key technology in security applications. Performing biometric screenings (e.g., facial recognition, liveness detection, temperature screening, medical mask detection) allows an operator of a facility or location of interest to create customized interactions for individual visitors or categories of visitors. For example, employees entering a building may be individually identified for record keeping purposes. More generally, visitors may be categorized based on whether or not they are bad actors (e.g., an imposter wearing a mask as a presentation attack may be flagged by a failed liveness detection). Efficiently executing multiple biometric screenings allows for more specific workflows to be customized to improve the handling of each visitor.

### SUMMARY

In general, one or more embodiments of the invention relate to a method for management of a visitor workflow. The method includes: receiving a video stream from a camera; in a first thread, generating one or more expiring buffers by processing frames of the video stream, using an object recognition algorithm to detect and track each face in the frames of the video stream and assign a universal unique identifier (UUID) for each face, and maintaining, for each UUID, a corresponding expiring buffer that includes a timer and the frames of the video stream showing the face corresponding to the UUID; and, in a second thread, processing a given expiring buffer by obtaining a biometric algorithm list, allocating frames of the given expiring buffer to a biometric thread pool comprising a biometric subthread for each algorithm of the biometric algorithm list, executing the biometric thread pool in parallel, harvesting biometric results from the biometric thread pool, determining a workflow based on the biometric results, and transmitting a command based on the workflow. The first thread and the second thread are executed at least partially in parallel.

In general, one or more embodiments of the invention relate to a system for management of a visitor workflow. The system includes a camera that generates a video stream and a processor. The processor is configured to: receive the video stream from the camera; in a first thread, generate one or more expiring buffers by processing frames of the video stream, using an object recognition algorithm to detect and track each face in the frames of the video stream and assign a universal unique identifier (UUID) for each face, and maintaining, for each UUID, a corresponding expiring buffer that includes a timer and the frames of the video stream showing the face corresponding to the UUID; and, in a second thread, process a given expiring buffer by obtaining a biometric algorithm list, allocating frames of the given expiring buffer to a biometric thread pool comprising a biometric subthread for each algorithm of the biometric algorithm list, executing the biometric thread pool in parallel, harvesting biometric results from the biometric thread pool, determining a workflow based on the biometric results, and transmitting a command based on the workflow. The processor is configured to execute the first thread and the second thread at least partially in parallel.

In general, one or more embodiments of the invention relate to a non-transitory computer readable medium (CRM) storing computer readable program code for management of a visitor workflow. The computer readable program code causes a processor to: receive a video stream from a camera; in a first thread, generate one or more expiring buffers by processing frames of the video stream, using an object recognition algorithm to detect and track each face in the frames of the video stream and assign a universal unique identifier (UUID) for each face, and maintaining, for each UUID, a corresponding expiring buffer that includes a timer and the frames of the video stream showing the face corresponding to the UUID; and, in a second thread, process a given expiring buffer by obtaining a biometric algorithm list, allocating frames of the given expiring buffer to a biometric thread pool comprising a biometric subthread for each algorithm of the biometric algorithm list, executing the biometric thread pool in parallel, harvesting biometric results from the biometric thread pool, determining a workflow based on the biometric results, and transmitting a command based on the workflow. The processor is configured to execute the first thread and the second thread at least partially in parallel.

Other aspects of the invention will be apparent from the following description and the appended claims.

### BRIEF DESCRIPTION OF DRAWINGS

FIG. 1 shows an implementation example according to one or more embodiments.

FIG. 2 shows a system in accordance with one or more embodiments of the invention.

FIG. 3 shows a processing hierarchy of the primary workflow in accordance with one or more embodiments of the invention.

FIG. 4 shows a flowchart of a first thread in accordance with one or more embodiments of the invention.

FIG. 5 shows a flowchart of a buffer process of the first thread in accordance with one or more embodiments of the invention.

FIGS. 6A-6C show flowcharts of buffer processes of the first thread in accordance with one or more embodiments of the invention.

FIG. 7 shows a flowchart of a second thread in accordance with one or more embodiments of the invention.

FIG. 8 shows a flowchart of a biometric subthread in accordance with one or more embodiments of the invention.

FIG. 9 shows a flowchart of a secondary workflow process in accordance with one or more embodiments of the invention.

FIG. 10 shows a computing system in accordance with one or more embodiments of the invention

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third) may be used as an adjective for an element (i.e., any noun in the application). The use of ordinal numbers is not to imply or create a particular ordering of the elements nor to limit any element to being only a single element unless expressly disclosed, such as by the use of the terms “before,” “after,” “single,” and other such terminology. Rather the use of ordinal numbers is to distinguish between the elements. By way of an example, a first element is distinct from a second element, and the first element may encompass more than one element and succeed (or precede) the second element in an ordering of elements.

In general, embodiments of the invention provide a method, a system, and a non-transitory computer readable medium (CRM) for management of a visitor workflow. One or more embodiments are directed to a method of analyzing video imagery to efficiently identify visitors at a location using biometric algorithms and launch one or more secondary workflows (e.g., a series of one or more commands to log the visit, grant access to a predetermined area, provide information, and/or accommodate the needs of the visitor or staff at the location). In other words, embodiments of this invention provide a generic algorithmic framework to gather and process biometric information in real time. More specifically, embodiments of this invention allow for the integration and simultaneous processing of multiple biometric algorithms with different requirements (e.g., different numbers of image frames to process a result with a predetermined confidence level) to improve responsiveness and lower a wait time for a secondary workflow to be executed.

A visitor may be any individual that approaches the location. For example, a visitor may be an authorized user (e.g., an individual with partial or full access to the location, an individual with recorded credentials maintained in a database by the owner/operator of the location), a guest (e.g., a temporary visitor, a contractor, a bystander, an individual without recorded credentials), and/or bad actors (e.g., any unauthorized individual, an individual with flagged credentials, a loiterer). Biometric algorithms are a useful tool for identifying and/or classifying visitors. For example, a visitor may be identified based on an employee record. Alternatively, an unknown visitor may be classified according to any number of appropriate categories (e.g., wearing an issued security badge, wearing a medical mask, having a temperature above a predetermined threshold). Each visitor may be classified according to multiple categories, a category that is specific to a single individual, and/or different categories from the examples provided in this disclosure. The above examples are neither limiting nor mutually exclusive.

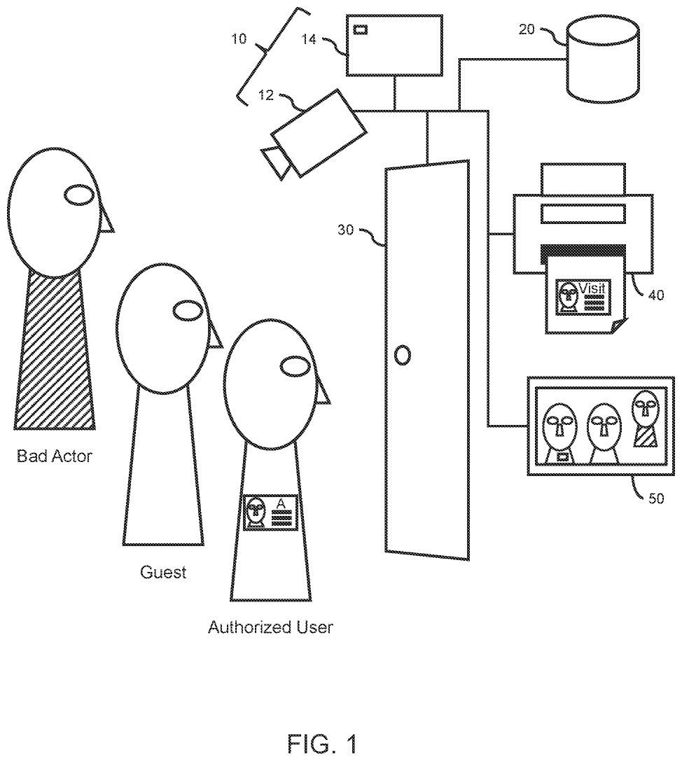

FIG. 1 shows an implementation example according to one or more embodiments.

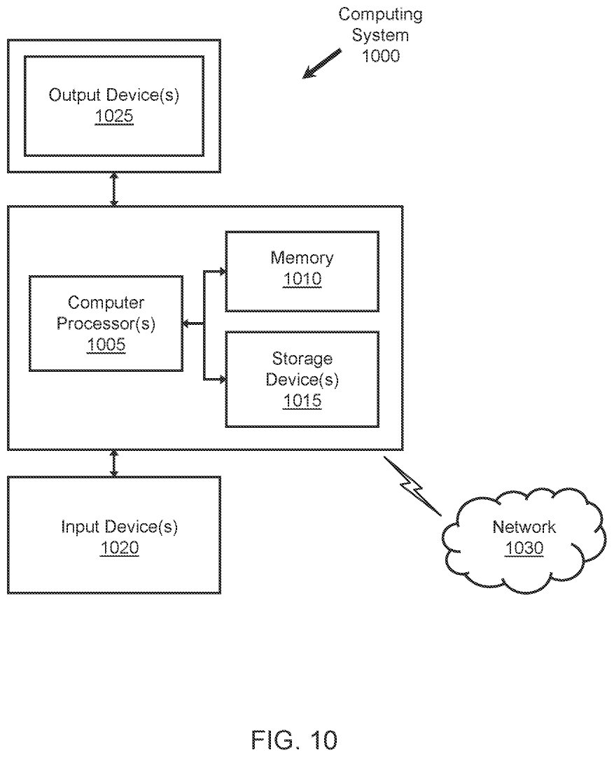

In FIG. 1, a camera system 10 includes one or more cameras 12 (e.g., a sensor) that monitor visitors within a location of interest and a computing system 14 (e.g., a processor, a computer, a server, a computing system 1000 as described in further detail below with respect to FIG. 10). The one or more cameras 12 produce a video stream that is processed by the computing system 14 in a primary workflow that detects each visitor and launches one or more secondary workflows to manage each visitor's interaction with the location. The primary workflow may comprise a first processing thread (i.e., a first thread) to generate one or more expiring buffers by processing the video stream with an object recognition algorithm (e.g., detection of faces, medical masks, badges) and a second processing thread (i.e., a second thread) to process a given expiring buffer by performing biometric processing, classification of visitors, and execution of one or more secondary workflows. The classification of each visitor may involve using biometric algorithms (e.g., facial recognition, liveness detection, temperature screening, gait analysis) and correlating the biometric results with a database 20 (e.g., for identification purposes).

For example, based on identifying a visitor as an employee that works at the location, the camera system 10 may send a command to unlock door 30. Furthermore, if the visitor is accompanied by a guest (e.g., a second visitor in proximity to the employee but not included in an employee database), the camera system 10 may send a command to a printer 40 to print a visitor badge. The badge may include an identifying image captured by the camera system 10. The camera system 10 may send a command to an interface 50 (e.g., a security display, a visitor kiosk) to display a log of the event and/or other useful information (e.g., a welcome message, a map).

In another example, the camera system 10 may identify a bad actor. For example, unauthorized personnel or any person at the location during an unauthorized timeframe may be considered a bad actor. In response, the camera system 10 may send a command to lock the door 30 (or a query to confirm a locked status), a command to notify security personnel, and/or a command to trigger an alarm (e.g., a warning on the interface 50 including a recorded image of the bad actor).

The example secondary workflows provided in this disclosure are neither limiting nor mutually exclusive, and any appropriate control actions may be combined as a secondary workflow.

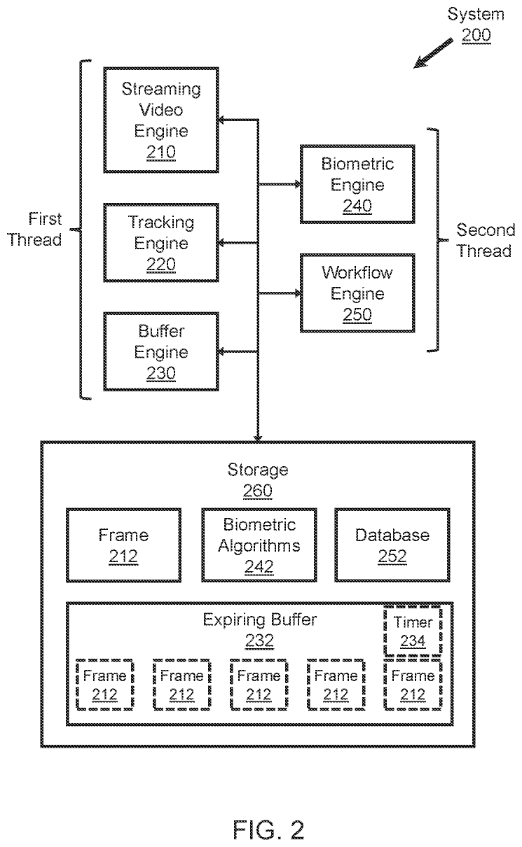

FIG. 2 shows a system in accordance with one or more embodiments of the invention.

In FIG. 2, the system 200 has multiple functional components, and may include, for example, a streaming video engine 210, a tracking engine 220, a buffer engine 230, a biometric engine 240, a workflow engine 250, and a storage 260. The functional components coordinate to execute the first thread and second thread in accordance with one or more embodiments. Each of these functional components may be located on or executed by the same computing device (e.g., a server, personal computer (PC), laptop, tablet PC, smartphone, kiosk) or on a combination of different computing devices connected by a network of any size (wired and/or wireless). Each of the functional components of the system 200 is described in further detail below.

The streaming video engine 210 is configured, as part of the first thread, to connect to one or more cameras that generate a video stream (e.g., one or more sensors of the camera system 10). The streaming video engine 210 outputs frames 212, which may include one or more images extracted from the video stream. A frame 212 may be a partial or a full frame image from the video stream. Furthermore, each frame 212 may include a timestamp and/or bounding boxes for objects in the image (e.g., faces) that are identified by the tracking engine 220.

The streaming video engine 210 may be implemented in hardware (i.e., circuitry), software, or any combination thereof. For example, the streaming video engine 210 may employ a real time streaming protocol (RTSP).

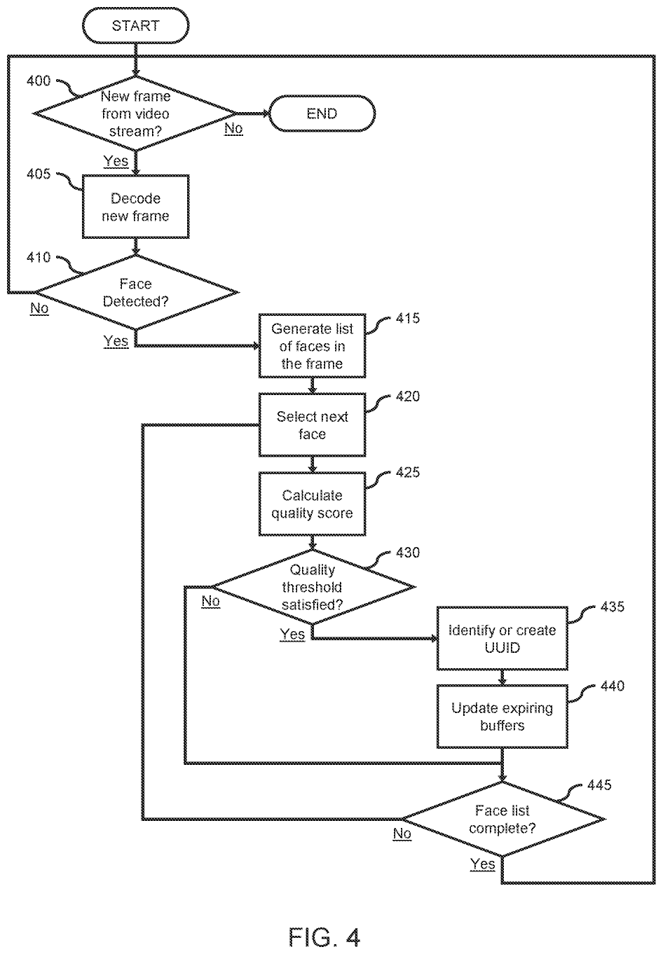

The tracking engine 220 is configured, as part of the first thread, to use one or more object recognition algorithms to detect and track objects in the frames 212. For example, the tracking engine 220 may use object recognition to detect and track faces, badges, uniforms, medical masks, other identifying features, etc. The detected objects across the frames 212 may be assigned a universal unique identifier (UUID) that is associated with the frame 212. For example, each unique face on a visitor at the location may be assigned a UUID and each frame 212 may include: a cropped image corresponding to the visitor's face (i.e., the detected object); a timestamp; and the assigned UUID. These processes are explained in further detail below with respect to FIG. 4.

The tracking engine 220 may be implemented in hardware (i.e., circuitry), software, or any combination thereof.

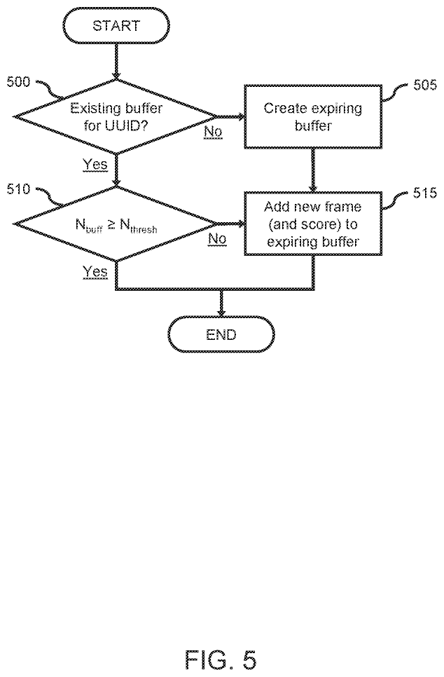

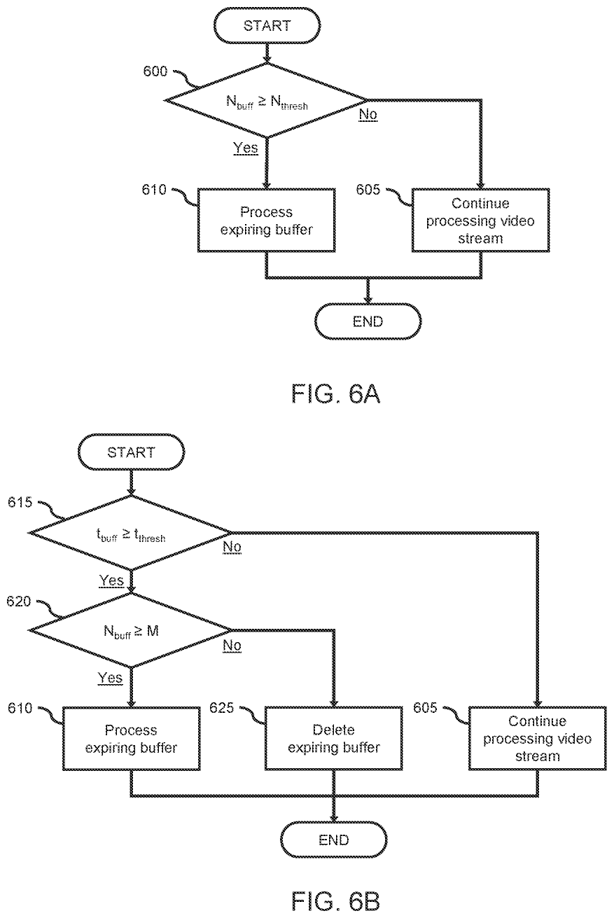

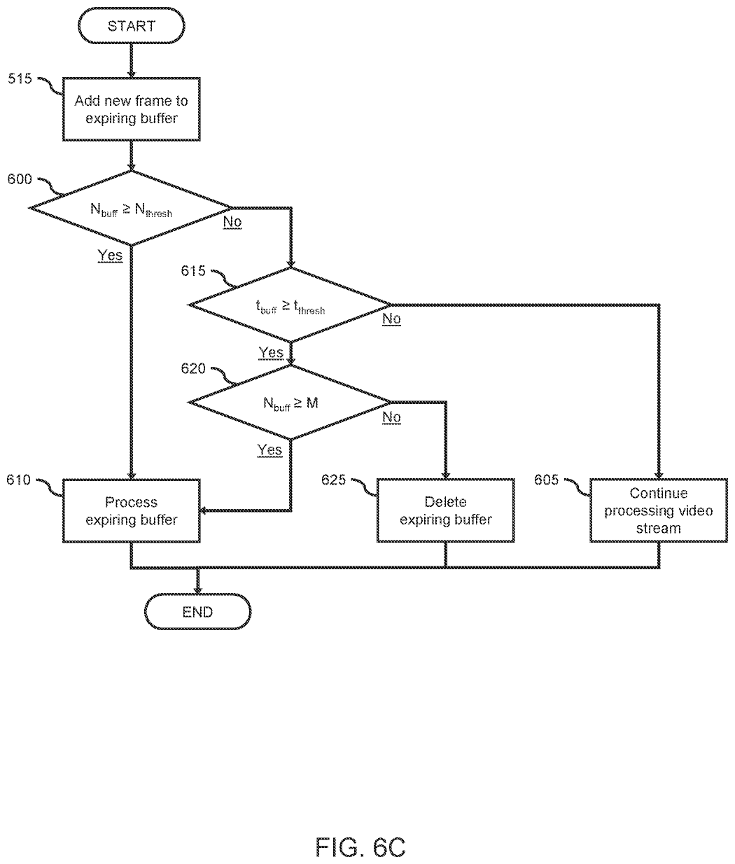

The buffer engine 230 is configured, as part of the first thread, to create, maintain, and reset expiring buffers 232. An expiring buffer 232 includes a number of frames 212 (i.e., a frame cache) corresponding to a specific UUID and a timer 234 described in further detail below with respect to FIG. 5. In one or more embodiments, the buffer engine 230 creates an expiring buffer 232 to correspond to each UUID generated by the tracking engine 220. In one or more embodiments, the buffer engine 230 maintains each expiring buffer 232 by adding frames 212 flagged with the corresponding UUID until the expiring buffer reaches a predetermined size (e.g., 12 frames). In one of more embodiments, once the expiring buffer 232 reaches the predetermined size, no additional frames are added even if the tracking engine 220 continues to generate additional frames flagged with the corresponding UUID. These processes are explained in further detail below with respect to FIGS. 5-6C.

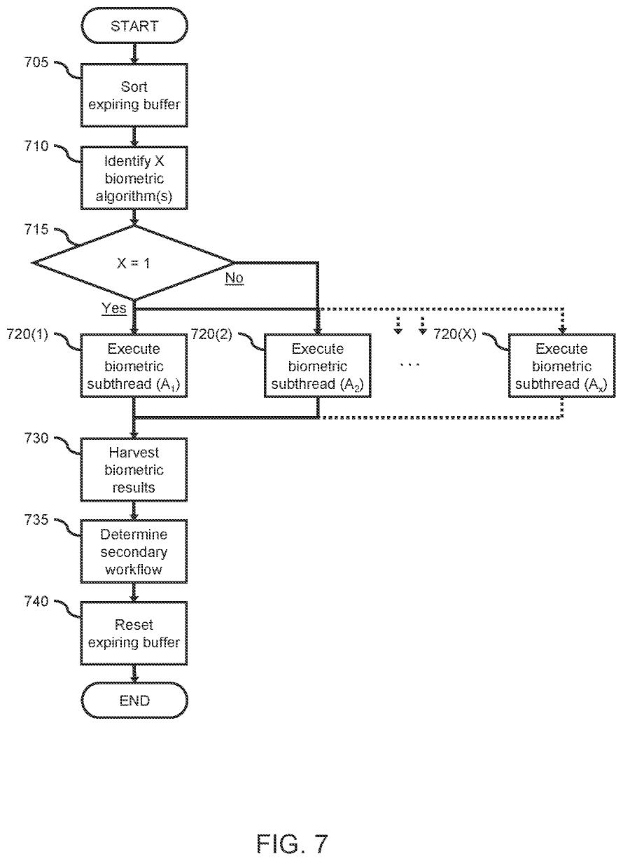

The buffer engine 230 is further configured to process an expiring buffer 232 when one or more predetermined conditions are met (e.g., a minimum number of frames are included, a timeout or expiration threshold is met). Processing an expiring buffer 232 includes preparing the frames 212 included therein for one or more biometric algorithms and/or clearing the frames 212 therein. In general, the buffer engine 230 manages frames included in each expiring buffer 232 such that a sufficient quantity and quality is achieved for successful processing by biometric engine 240. These processes are explained in further detail below with respect to FIG. 7.

The buffer engine 230 may be implemented in hardware (i.e., circuitry), software, or any combination thereof.

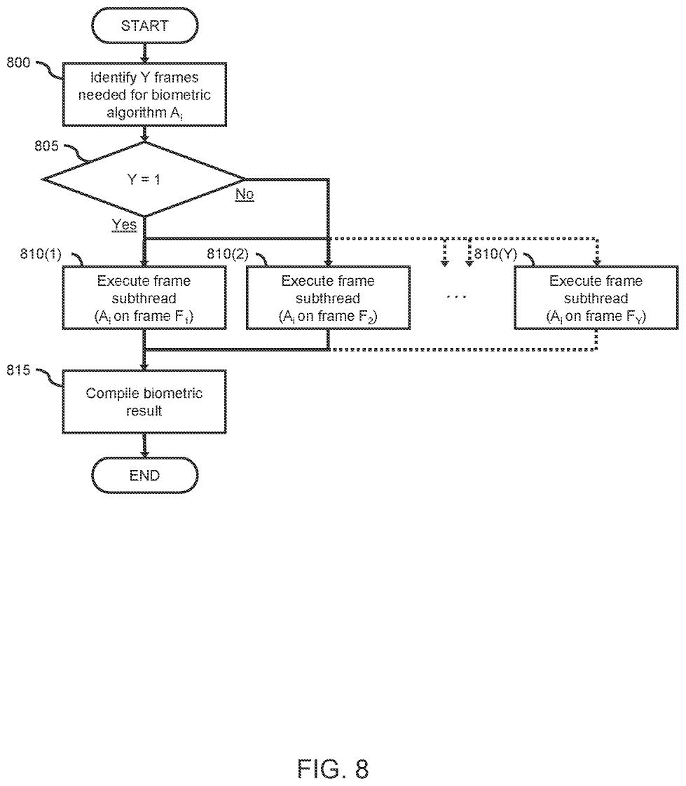

The biometric engine 240 is configured, as part of the second thread, to classify and/or identify a visitor by executing one or more biometric algorithms 242. In one or more embodiments, the biometric engine 240 maintains a database including the biometric algorithms 242, the parameters or requirements of each biometric algorithm 242 (e.g., a minimum number of frames required to operate with one or more levels of confidence), and the resources required to execute the biometric algorithms 242. For example, the biometric engine 240 may generate a biometric thread pool comprising an individual biometric subthread for each algorithm in a predetermined list of biometric algorithms 242. Processing each biometric subthread may include: allocating frames 212 from an expiring buffer 232; executing the biometric algorithm 242 assigned to the biometric subthread; and harvesting the biometric results. These processes are explained in further detail below with respect to FIG. 8.

The biometric engine 240 may be implemented in hardware (i.e., circuitry), software, or any combination thereof.

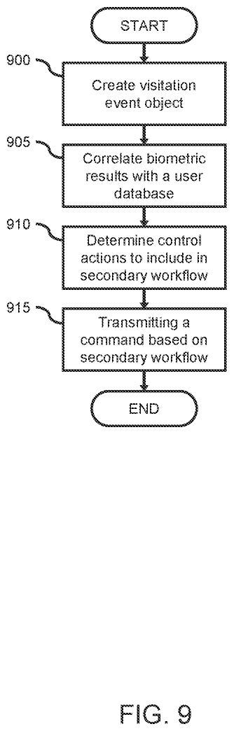

The workflow engine 250 is configured, as part of the second thread, to determine and execute an appropriate secondary workflow based on the biometric results output by the biometric engine 240. In one or more embodiments, the workflow engine 250 maintains a database 252 of secondary workflows (e.g., control door access, control badge printer operations, control display operations, control event recording/reporting), the control actions, parameters, and requirements of each secondary workflow (e.g., authorization credentials for accessing restricted areas, employee database, badge generation protocols), and the command resources required to execute the secondary workflows (e.g., communication protocols to interface with a security system, a badge printer, a display, or any other appropriate external system). For example, the workflow engine 250 may: create and store a visitation event object corresponding to the visitation event; correlate the biometric results from the biometric engine 240 with a database 252 to determine the appropriate secondary workflow; execute one or more commands or control actions based on the appropriate secondary workflow. These processes are explained in further detail below with respect to FIG. 9.

The workflow engine 250 may be implemented in hardware (i.e., circuitry), software, or any combination thereof.

The storage 260 is configured to store frames 212, expiring buffers 232, biometric algorithms 242, a database 252, and any appropriate information required by the streaming video engine 210, the tracking engine 220, the buffer engine 230, the biometric engine 240, and the workflow engine 250. In other words, system 200 operates by connecting and coordinating the functional components and their inputs/outputs via the storage 260.

The storage 260 may be implemented in hardware (i.e., circuitry), software, or any combination thereof.

Although the system 200 is shown as having six functional components (210, 220, 230, 240, 250, and 260), in other embodiments of the invention, the system 200 may have more or fewer functional components. Furthermore, the functionality of each functional component described above may be shared among multiple functional components or performed by a different functional component than that described above. In addition, each functional component may be utilized multiple times in serial or parallel to carry out distributed, repeated, and/or iterative operations.

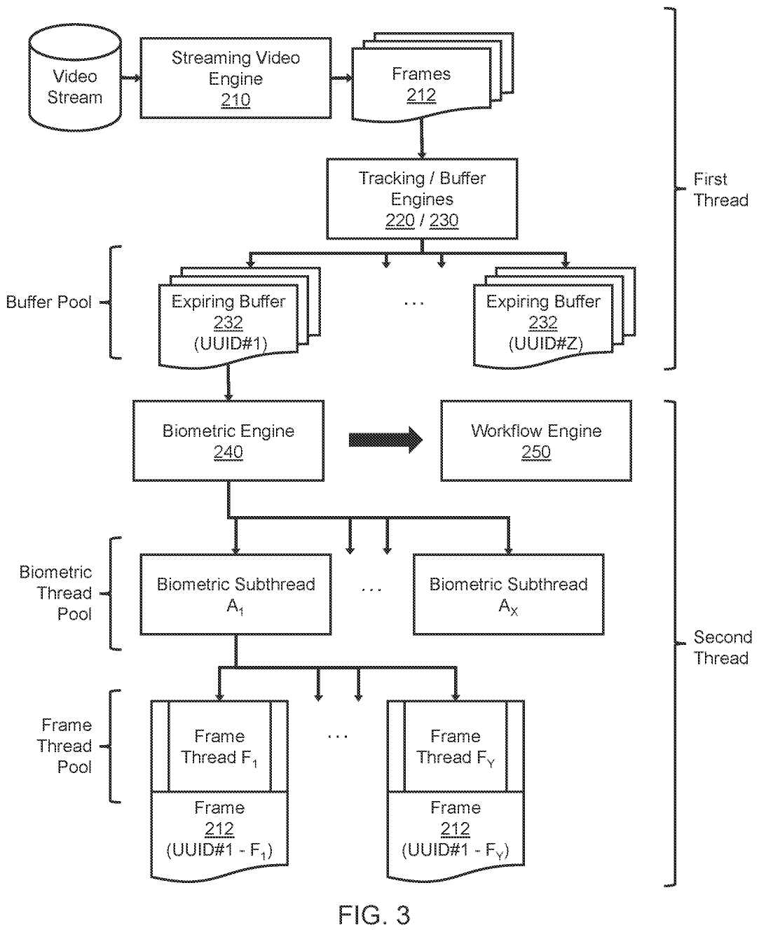

FIG. 3 shows a processing hierarchy of the primary workflow in accordance with one or more embodiments of the invention.

As discussed above, the system 200 executes a primary workflow to detect, track, and classify each visitor in order to launch one or more secondary workflows that manage the visitor's interaction with the location. Embodiments of the invention utilize a first thread to generate the expiring buffers 232 and one or more second threads to individually process the expiring buffers 232 when one or more predetermined conditions are met.

In the first thread, a video stream is processed by the streaming video engine 210 to output the frames 212. The tracking engine 220 processes the frames 212 by detecting objects (e.g., object 1, object 2, . . . , object Z) in each frame 212 and assigning the appropriate UUIDs (e.g., UUID #1, UUID #2, . . . , UUID #Z) to each frame 212. The buffer engine 230 maintains a pool of expiring buffers 232 by allocating each frame 212 to their corresponding expiring buffer 232 or discarding the frame 212 based on the condition of the corresponding expiring buffer 232. If predetermined conditions to begin processing a given expiring buffer 232 are met, the given expiring buffer 232 is passed to the second thread while the first thread continues to process the video stream.

In the second thread, the biometric engine 240 obtains a biometric algorithms list and generates a biometric subthread for each algorithm (e.g., algorithm A₁, algorithm A₂, . . ., algorithm A_{X}) of the biometric algorithm list. The biometric engine 240 allocates the frame cache of the given expiring buffer 232 to each biometric subthread such that biometric algorithms A₁ . . . A_{X} may be simultaneously executed in real time. Furthermore, if a biometric algorithm requires processing multiple frames (e.g., liveness detection may require multiple frames, facial recognition may be improved by averaging results from multiple frames), a biometric subthread may generate a frame thread pool comprising multiple frame threads (e.g., frame thread 1, frame thread 2, . . . , frame thread Y) to simultaneously process frames F₁ . . . F_{Y} in real time. The results from the frame subthreads are harvested (e.g., averaged, compiled, or otherwise processed) to produce a biometric result for the biometric subthread. The biometric results from the biometric subthreads are harvested by the biometric engine 240 in real time and passed to the workflow engine 250 to determine an appropriate secondary workflow to execute as soon as possible.

In other words, embodiments of the invention (1) buffer frames 212 to the expiring buffers 232 in the first thread, (2) independently process the expiring buffers 232 in parallel instances of the second thread (either upon filling or expiration of the buffer frame cache), and (3) launch one or more biometric subthreads in each instance of the second thread to obtain biometrics in real time. By executing the first thread and second thread in parallel, the amount of time a visitor has to wait for biometric analysis to complete and the secondary workflow to be executed can be minimized.

Although the processing hierarchy of FIG. 3 is shown as having distinct layers and threads, in other embodiments of the invention, the processing hierarchy may have more or fewer elements. Furthermore, the functionality of each element described above may be shared among multiple elements or further subdivided into additional elements. In general, each thread or layer may be implemented multiple times in serial or parallel to carry out distributed, repeated, and/or iterative operations.

FIG. 4 shows a flowchart of a first thread in accordance with one or more embodiments of the invention. In the first thread, the system 200 will process a video stream from the camera 12 to detect and track visitors and prepare expiring buffers that will be used (consumed) by the second thread.

For example, in a non-limiting scenario, an employee and a guest approach the main entrance to a building equipped with a camera system 10 and system 200.

At 400, the streaming video engine 210 determines whether or not a new frame from the video stream is available for processing.

When the determination at 400 is NO (e.g., the video stream is turned off or the system is disable by disconnecting from the video stream), the process ends.

When the determination at 400 is YES (e.g., while the video stream is available, one or more sensors of the camera system 10 have an active video stream), the process continues to 405.

At 405, the streaming video engine 210 decodes the new frame. In one or more embodiments, the streaming video engine 210 may process multiple frames from multiple sensors in parallel.

At 410, the tracking engine 220 determines whether or not a face is detected in the frame.

When the determination at 410 is NO (e.g., the visitors are not in the field of view of the camera system 10 or the faces are obstructed), the process returns to 400 to continue processing the video stream.

When the determination at 410 is YES (e.g., the face of one or both visitors is detected by an object recognition algorithm), the process continues to 415.

At 415, the tracking engine 220 detects any faces in the new frame and generates a list of faces. In the present example, the tracking engine 220 may detect and track two faces corresponding to the two visitors. The tracking engine 220 may define a bounding box around each face to focus on during subsequent analysis.

At 420, the tracking engine 220 selects a face from the list of faces for further analysis. In one or more embodiments, the tracking engine 220 may process multiple faces from the list of faces in parallel (e.g., executing process elements 425-440 in parallel threads for each of the two visitors).

At 425, the tracking engine 220 calculates a quality score for the selected face based on one or more quality metrics. The tracking engine 220 may pass the image through one or more filters or evaluations to ensure the face has sufficient quality for biometric processing (e.g., not too blurry, not too close to an image border, proper roll/pitch/yaw orientation for analysis). The quality score may be numeric score that is compiled (e.g., averaged, summed) from multiple filters/evaluations, one or more Boolean flags, any appropriate metric, or any combination thereof.

At 430, the tracking engine 220 determines whether or not the quality score for the selected face satisfies a predetermined quality threshold. The quality threshold may be a numeric threshold value, one or more Boolean flag requirements, any appropriate threshold, or any combination thereof.

When the determination at 430 is NO (i.e., the image is not suitable for processing), the process continues to 445 to continue processing the list of faces (e.g., poor quality frames are discarded and the system 200 must wait for a new frame with a better quality).

When the determination at 430 is YES (i.e., the image is suitable for processing), the process continues to 435.

At 435, the tracking engine 220 assigns a universal unique identifier (UUID) for the selected face. Assigning the UUID may involve creating a new UUID if the selected face is being detected for the first time or identifying the UUID that was previously assigned to the selected face (e.g., UUID assigned in a previously analyzed frame, UUID include in employee database). In the present example, the employee may have a preexisting UUID #1 and the guest may be assigned a new UUID #2.

At 440, the buffer engine 230 updates the expiring buffers that correspond to each of the UUIDs assigned in the new frame. In other words, for each UUID assigned, the buffer engine 230 maintains the corresponding expiring buffer by performing one or more of the following actions: creating the expiring buffer if one does not exist for the UUID; add the new frame to the corresponding expiring buffer if it is not full; discard the new frame when processing is complete. In the present example, the expiring buffer corresponding to UUID #1 and UUID #2 are updated with the new frame. Maintaining the expiring buffers is described in further detail below with respect to FIGS. 5-6C.

At 445, the tracking engine 220 determines whether or not the list of faces has been completely processed.

When the determination at 445 is NO (e.g., more faces need to be processed), the process returns to 420 to continue processing the list of faces.

When the determination at 445 is YES (e.g., all faces have been processed), the process returns to 400 to continue processing the video stream.

In general, the first thread processes a video stream to detect and track the visitors and prepare corresponding expiring buffers.

FIG. 5 shows a flowchart of a buffer process of the first thread in accordance with one or more embodiments of the invention. In the present non-limiting example, when system 200 receives a new frame, the buffer engine 230 executes different sequences for the employee and the guest. For example, the employee has an existing UUID #1 and may have a preexisting expiring buffer (e.g., an empty buffer that expired and was reset (empty with no timestamp) after their previous visit, a filled buffer because the employee was waiting for the guest in view of the camera). On the other hand, the guest was assigned a new UUID #2 and may need a new expiring buffer created.

At 500, the buffer engine 230 determines whether or not the UUID has a corresponding expiring buffer.

When the determination at 500 is NO (e.g., the guest without a preexisting expiring buffer), the process continues to 505.

When the determination at 500 is YES (e.g., the employee with a preexisting expiring buffer), the process continues to 510.

At 505, the buffer engine 230 creates a new expiring buffer for the UUID. The buffer engine 230 may include a timer 234 in the newly created expiring buffer. The timer 234 may be used to determine when the buffer has expired. For example, when a bystander passes by the camera system 10, a small number of frames may be assigned to a new expiring buffer. Because the bystander is simply passing by, no more frames are added to the expiring buffer and the expiring buffer is never processed. The timer 234 will reach an expiration threshold and cause the expiring buffer to be reset (frames deleted, timer reset).

At 510, the buffer engine 230 performs a maximum frame threshold comparison to determine whether or not a total number of frames (N_{buff}) included in the preexisting expiring buffer is equal to or greater than a predetermined maximum size (Nₜₕᵣₑₛₕ). The predetermined maximum size may be any number of frames (e.g., a large enough pool that statistically includes enough quality frames to perform biometric analysis).

When the determination at 510 is NO (e.g., the expiring buffer is empty or only partially filled), the process continues to 515.

When the determination at 510 is YES (e.g., the expiring buffer is full), the process ends and the frame is discarded. In other words, the expiring buffer contains enough frames to be processed and further processing of the new frame is not required. This filtering reduces the resources required by the system (e.g., processing resources, processing time, storage requirements).

At 515, the buffer engine 230 adds the new frame and associated quality score to the expiring buffer. If the new frame is the first frame being added to an empty buffer, the timer 234 included in the expiring buffer may be restarted. In one or more embodiments, the timer 234 is restarted regardless of how many frames are present in the expiring buffer (e.g., extending the expiration timeout deadline to allow a user more time to approach the sensor).

Therefore, in the present example, this buffer process included in the first thread maintains the corresponding expiring buffers for the two visitors.

FIGS. 6A-6C show flowcharts of buffer processes of the first thread in accordance with one or more embodiments of the invention. Specifically, FIGS. 6A-6C show embodiments of determining when to send an expiring buffer to the second thread for processing.

FIG. 6A shows a flowchart of a first trigger comparison in accordance with one or more embodiments of the invention.

At 600, the buffer engine 230 executes a maximum frame threshold comparison to determine whether or not the total number of frames (N_{buff}) included in the expiring buffer is equal to or greater than the predetermined maximum size (Nₜₕᵣₑₛₕ).

When the determination at 600 is NO (e.g., the expiring buffer is empty or only partially filled), the process continues to 605.

When the determination at 600 is YES (e.g., the expiring buffer is full), the process continues to 610.

At 605, the expiring buffer is not processed by the second thread. In other words, the expiring buffer does not contain enough frames and the buffer engine 230 must wait for further frames to be added before the expiring buffer can be passed to the biometric engine 240. This may prevent wasting system resources on false starts where the system attempts biometric analysis only to fail due to a lack of suitable frames for analysis.

At 610, the expiring buffer is passed to the second thread for processing (e.g., passed to the biometric engine 240). By waiting for Nₜₕᵣₑₛₕ frames to be collected, the invention prevents wasting processing resources, processing time, and storage space on the second thread when the data is expected to provide insufficient results.

FIG. 6B shows a flowchart of a second and third trigger comparison in accordance with one or more embodiments of the invention.

At 615, the buffer engine 230 executes a second trigger comparison to determine whether or not a value (t_{buff}) of the timer in the expiring buffer is greater than or equal to an expiration threshold (tₜₕᵣₑₛₕ) (e.g., a timeout parameter). The expiration threshold (e.g., 7 seconds) may be determined based on any appropriate criterion. For example, the expiration threshold may be based on the expected amount of time to collect Nₜₕᵣₑₛₕ frames of sufficient quality. As discussed above, in the case of a passing bystander that briefly appears in the video stream, only a small number of frames may be allocated to an expiring buffer. After the expiration threshold, the bystander is not expected to return to the camera sensor field of view and the expiring buffer is reset (frames deleted, timer reset) to free up resources.

When the determination at 615 is NO, the process continues to 605, as described above (i.e., the expiring buffer is not processed by the second thread).

When the determination at 615 is YES, the process continues to 620.

At 620, the buffer engine 230 executes a third trigger comparison to determine whether or not the total number of frames (N_{buff}) included in the expiring buffer is equal to or greater than the predetermined minimum size (M). The predetermined minimum size (e.g., 6 frames) may be a minimum number of frames required to rule out a passing bystander compared to an intentional approach by a visitor (i.e., promoting processing of intentional interactions with the sensor). The predetermined minimum size may be a minimum number of frames required for one or more biometric algorithms to execute with a predetermined level of confidence.

When the determination at 620 is NO, the process continues to 625.

When the determination at 620 is YES, the process continues to 610, as described above (i.e., the expiring buffer is passed to the second thread for processing).

At 625, the buffer engine 230 resets the expiring buffer by deleting all frames within the expiring buffer. In other words, the expiring buffer does not contain enough frames and the system 200 deletes the expiring buffer because it does not expect new frames to be added. This may prevent wasting system resources on false starts on passing bystanders.

In one or more embodiments, the first, second, and third trigger comparisons may be independently performed at any time by the buffer engine 230. For example, the trigger comparisons may be performed together or separately at regular intervals, intermittently, when new frames are decoded, and/or when new frames are added to a buffer. In one or more embodiments, the second trigger comparison may be performed asynchronously based on the timer included in the expiring buffer. As shown in FIG. 6C, the first, second, and third trigger comparisons may be combined and executed after any frame is added to an expiring buffer.

FIG. 7 shows a flowchart of a second thread in accordance with one or more embodiments of the invention. In the second thread, the system 200 processes a given expiring buffer and launches one or more secondary workflows based on biometric analysis of the expiring buffer. Continuing the above example, in the non-limiting scenario where an employee and a guest approach the main entrance of a building, the system 200 executes two instances of the second thread (i.e., one instance for each visitor). In each instance of the second thread, one of the expiring buffers corresponding to UUID #1 and UUID #2 is processed as soon as the buffer satisfies one or more conditions for processing (e.g., the first, second, and/or third trigger comparisons, manual trigger by a user or the visitor). In the meantime, the first thread continues to process the video stream from the camera 12 to detect and track other visitors and prepare expiring buffers.

At 705, the biometric engine 240 receives the given expiring buffer and sorts the frames within the given expiring buffer. In one or more embodiments, the biometric engine 240 identifies the back portion of the frame cache (i.e., the most recently acquired frames). The biometric engine 240 may sort the back portion of frames by the quality scores assigned at step 425. In one or more embodiments, the biometric engine 240 may only use frames exceeding M (i.e., the predetermined minimum size) and discard any earlier frames.

At 710, the biometric engine 240 obtains a biometric algorithm list that identifies a number of biometric algorithms (e.g., algorithms A₁, A₂, . . . , A_{X}) to perform. The biometric algorithm list may be stored in a database that maintains a plurality of lists with different levels of security. In one or more embodiments, the biometric engine 240 may obtain any of the biometric algorithms Aᵢ from the database. Biometric algorithms may include facial recognition, liveness detection, temperature screening, thumbprint analysis, retinal scan, gait analysis, etc. Furthermore, the biometric algorithm list may include any non-biometric algorithms (e.g., object detection/classification) that may be appropriate to managing a visitor workflow.

At 715, the biometric engine 240 determines whether or not the number of biometric algorithms X in the biometric algorithm list is equal to 1.

When the determination at 715 is YES, the process continues by launching a single biometric subthread for the single biometric algorithm A₁ in the biometric algorithm list.

When the determination at 715 is NO, the process continues by launching X biometric subthreads, one for each biometric algorithm A₁, A₂, . . . , A_{X} in the biometric algorithm list.

At 720, the biometric engine 240 allocates the sorted frames of the given expiring buffer to a biometric thread pool comprising a biometric subthread for each algorithm of the biometric algorithm list. In other words, the best frames from the given expiring buffer are input into each biometric algorithm in parallel threads. This may minimize the amount of time a visitor has to wait for biometric analysis to complete and the secondary workflow to be executed. Executing a biometric subthread is explained in further detail below with respect to FIG. 8.

At 730, the biometric engine 240 harvests biometric results from the biometric thread pool in parallel. In other words, individual biometric results may be collected as they become available to initiate one or more secondary workflows as soon as possible. For example, temperature screening may be completed faster than facial recognition or liveness detection.

At 735, the biometric engine 240 determines one or more secondary workflows based on the harvested biometric results. This processes is explained in further detail below with respect to FIG. 9.

At 740, the biometric engine 240 resets the given expiring buffer by deleting all frames within the given expiring buffer. In other words, the given expiring buffer is reset in preparation for the next instance that the visitor corresponding to the given UUID is detected. In one or more embodiments, the given expiring buffer may be disabled (e.g., no new frames can be added) for a predetermined amount of time to prevent redundant analysis of the same event (e.g., an employee loitering in the area).

FIG. 8 shows a flowchart of a biometric subthread in accordance with one or more embodiments of the invention. In one or more embodiments, the system 200 may produce a biometric result by distributing the back portion of frames allocated to a given biometric subthread among multiple frame subthreads for processing. For example, a facial recognition algorithm may require a single frame to produce a biometric result, a thermal screening algorithm may require a single frame to produce a biometric result, a liveness algorithm (i.e., detection of a presentation attack) may require analysis of three frames to produce a biometric result, a mask detection algorithm may require five frames to produce a biometric result.

At 800, the biometric engine 240 identifies a number Y of frames (e.g., frames F₁, F₂, . . . , F_{Y}) required to produce a biometric result from a given biometric algorithm Aᵢ. The number Y may be a parameter associated with the biometric algorithm Aᵢ in a database.

At 805, the biometric engine 240 determines whether or not the number of frames Y in the biometric algorithm list is equal to 1.

When the determination at 805 is YES, the process continues by launching a single frame subthread for processing frame F₁ with biometric algorithm Aᵢ.

When the determination at 805 is NO, the process continues by launching Y frame subthreads, one for each frame F₁, F₂, . . . , F_{Y}.

At 810, the biometric engine 240 allocates the required number of frames Y to a frame thread pool comprising a frame subthread for each frame required to produce a biometric result from a given biometric algorithm Aᵢ. The frame subthreads are processed in parallel to minimize the amount of time to produce a biometric result. Results from the frame thread pool may be harvested into a list as each frame subthread completes until all frames have been processed.

At 815, the biometric engine 240 compiles a biometric result from the harvested output of the frame thread pool. In one or more embodiments, the biometric result may be a list or an average of the results from the individual frame subthreads. The biometric result may be passed to the workflow engine 250 to determine a secondary workflow, as explained in further detailed below with respect to FIG. 9.

FIG. 9 shows a flowchart of a secondary workflow process in accordance with one or more embodiments of the invention. In the second thread, the system 200 processes the biometric results to identify and launch one or more secondary workflows based on biometric analysis of the expiring buffer.

At 900, the workflow engine 250 creates and outputs a visitation event object that includes a timestamp, the biometric results, and any other appropriate event details determined from the processing of the given expiring buffer. For example, the visitation event object may include a recognized face with corresponding information retrieved from a database, a liveness result score, thermal screening details, etc. If a particular biometric result is inconclusive or could not be completed (e.g., failure of one or more subthreads) the visitation event object may mark (e.g., N/A result) or omit that component. In one or more embodiments, the biometric engine 240 may create the visitation event object as soon as results are compiled from the parallel biometric subthreads and frame subthreads. In one or more embodiments, visitation event objects from separate instances of the second thread may be cross-referenced (e.g., the employee is noted as being accompanied by a guest, the employee is flagged for allowing tailgate access to a bad actor that is flagged in a different visitation event object).

At 905, the workflow engine 250 correlates the biometric results of the visitation event object with a database. Continuing the above example, in the non-limiting scenario where an employee and a guest approach the main entrance of a building, a facial recognition result in the visitation event object for the employee may be cross-referenced with a user database to identify the employee by name. The database may further include a security profile associated with the employee. The security profile may include a first level of access available to just the employee and a second level of access available to the employee when accompanied by a guest. In addition, the visitation event object for the guest may be added to the database to have an image of the guest and a security log on record.

At 910, the workflow engine 250 determines one or more control actions to include in a secondary workflow based on the biometric results. In the above example, based on the presence of the guest, the system may generate a secondary workflow that includes unlocking a door included in the second level of access (another door corresponding to the first level of access may be locked due to the employee being accompanied by unknown guest) and printing a visitor badge for the guest.

In one or more embodiments, the workflow engine 250 may generate a command for an authorized control action (e.g., unlock a door) based on a successful correlation of the facial recognition result with the user database and a successful liveness result (i.e., no presentation attack detected). Alternatively, the workflow engine 250 may generate a command with an unauthorized control action (e.g., lock a door) based on a failure to correlate the facial recognition result with the user database or a failed liveness result (i.e., presentation attack detected).

In yet another embodiment, the workflow engine 250 may generate a command for an authorized control action (e.g., unlock a door) based on a temperature screening and a specified threshold.

The example control actions provided in this disclosure are neither limiting nor mutually exclusive, and any number or combination of control actions may be compiled into an appropriate secondary workflow.

At 915, the workflow engine 250 transmits one or more commands to execute the control actions to include in the secondary workflow. In one or more embodiments, the workflow engine 250 may reset the expiring buffer by deleting all frames within the expiring buffer and restart the timer included in the expiring buffer to prepare the expiring buffer for the next visit.

Although the actions of FIGS. 4-9 are described in a specific order, in other embodiments of the invention, each action described above may be performed in a different order or by a different functional component of the system. Furthermore, actions may be implemented multiple times in serial or parallel to carry out distributed, repeated, and/or iterative operations.

FIG. 10 shows a computing system 1000 in accordance with one or more embodiments of the invention. Embodiments of the invention may be implemented on virtually any type of computing system, regardless of the platform being used. For example, the computing system 1000 may be one or more mobile devices (e.g., laptop computer, smart phone, personal digital assistant, tablet computer, or other mobile device), desktop computers, servers, blades in a server chassis, or any other type of device that includes at least the minimum processing power, memory, and input/output device(s) to perform one or more embodiments of the invention.

For example, as shown in FIG. 10 the computing system 1000 may include one or more computer processor(s) 1005, associated memory 1010 (e.g., random access memory (RAM), cache memory, flash memory), one or more storage device(s) 1015 (e.g., a hard disk, an optical drive such as a compact disk (CD) drive or digital versatile disk (DVD) drive, a flash memory stick), and numerous other elements and functionalities. The computer processor(s) 1005 may include an integrated circuit for processing instructions. For example, the computer processor(s) 1005 may be one or more cores, or micro-cores of a processor. Although the computing system 1000 in FIG. 10 is shown as having three components, in other embodiments of the invention, the computing system 1000 may have more or fewer components.

Furthermore, the functionality of each component described above may be shared among multiple components or performed by a different component. For example, each component may be utilized multiple times in serial or parallel to carry out repeated, iterative, or parallel operations. Further, one or more component of the aforementioned computing system 1000 may be located at a remote location and be connected to the other elements over a network 1030. One or more embodiments of the invention may be implemented on a distributed system having a plurality of processing nodes, where each portion of the invention may be located on a different processing node within the distributed system.

The computing system 1000 may also include one or more input device(s) 1020, such as a camera, sensor, biometric sensor, touchscreen, keyboard, mouse, microphone, touchpad, electronic pen, or any other type of input device. Further, the computing system 1000 may include one or more output device(s) 1025, such as a screen (e.g., a liquid crystal display (LCD), a plasma display, touchscreen, cathode ray tube (CRT) monitor, or other display device), a projector, a printer, external storage, or any other output device. One or more of the output device(s) may be the same or different from the input device(s). Many different types of computing systems exist, and the aforementioned input/output device(s) may take other forms.

The computing system 1000 may be wired or wirelessly connected to a network 1030 (e.g., a local area network (LAN), a wide area network (WAN) such as the Internet, mobile network, or any other type of network) via a network interface connection (e.g., a structural transceiver such as a communication port or antenna (not shown)). The network 1030 may connect the computing system 1000 to one or more utilities (e.g., a door lock, a badge printer, a kiosk system, a security system, an alarm system, a specific computer terminal) that execute control actions based on a secondary workflow.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Embodiments of the invention may have one or more of the following advantages: reducing hardware and computational resource requirements (i.e., less processing power, lower memory requirements, lower power requirements, lower communication bandwidth requirements) to complete multiple biometric screenings; improving the responsiveness of biometric sensor systems by integrating multiple biometric screenings into a parallelized hierarchy that can be executed in real time; and improving a visitor's interaction with a location by minimizing the amount of time a visitor has to wait for biometric analysis to complete and a secondary workflow to be executed.

Although the disclosure has been described with respect to a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A method for management of a visitor workflow, the method comprising:
receiving a video stream from a camera;
in a first thread, generating one or more expiring buffers by:
processing frames of the video stream;
using an object recognition algorithm to detect and track each face in the frames of the video stream and assign a universal unique identifier (UUID) for each face; and
maintaining, for each UUID, a corresponding expiring buffer that includes a timer and the frames of the video stream showing the face corresponding to the UUID;
in a second thread, processing a given expiring buffer by:
obtaining a biometric algorithm list;
allocating frames of the given expiring buffer to a biometric thread pool comprising a biometric subthread for each algorithm of the biometric algorithm list;
executing the biometric thread pool in parallel;
harvesting biometric results from the biometric thread pool;
determining a workflow based on the biometric results; and
transmitting a command based on the workflow;
wherein the first thread and the second thread are executed at least partially in parallel.

2. The method of claim 1,
wherein the first thread maintains each corresponding expiring buffer by executing a maximum frame threshold comparison to determine whether or not to add a new frame to the corresponding expiring buffer,
wherein the maximum frame threshold comparison includes comparing a total number of frames in the corresponding expiring buffer to a predetermined maximum size,
in response to determining that the total number of frames in the corresponding expiring buffer is less than the predetermined maximum size, the new frame is added to the corresponding expiring buffer, and
in response to determining that the total number of frames in the corresponding expiring buffer is greater than or equal to the predetermined maximum size, the new frame is not added to the corresponding expiring buffer.

3. The method of claim 1,
wherein the first thread maintains each corresponding expiring buffer by executing a first trigger comparison to determine whether or not to trigger the processing of the corresponding expiring buffer by the second thread,
wherein the first trigger comparison includes comparing a total number of frames in the corresponding expiring buffer to a predetermined maximum size,
in response to determining that the total number of frames in the expiring buffer is greater than or equal to the predetermined maximum size, the corresponding expiring buffer is processed by the second thread, and
in response to determining that the total number of frames in the corresponding expiring UUID buffer is less than the predetermined maximum size, the corresponding expiring buffer is not processed by the second thread.

4. The method of claim 1,
wherein the first thread maintains each corresponding expiring buffer by executing a second trigger comparison to determine whether or not to trigger the processing of the corresponding expiring buffer by the second thread,
wherein the second trigger comparison includes comparing the timer of the corresponding expiring buffer to an expiration threshold,
in response to determining that the timer of the corresponding expiring buffer is less than the expiration threshold, the corresponding expiring buffer is not processed by the second thread, and
in response to determining that the timer of the corresponding expiring buffer is greater than or equal to the expiration threshold, the first thread executes a third trigger comparison,
wherein the third trigger comparison includes comparing a total number of frames in the corresponding expiring buffer to a predetermined minimum size,
in response to determining that the total number of frames in the corresponding expiring buffer is greater than or equal to the predetermined minimum size, the corresponding expiring buffer is processed by the second thread, and
in response to determining that the total number of frames in the corresponding expiring buffer is less than the predetermined minimum size, the first thread resets the corresponding expiring buffer by deleting the frames of the corresponding expiring buffer and resetting the timer of the corresponding expiring buffer.

5. The method of claim 1,
wherein the object recognition algorithm of the first thread is configured to:
detect one or more faces in a new frame of the video stream; and
calculate a quality score for each face based on an image quality metric,
wherein the quality score and a timestamp are included with the new frame.

6. The method of claim 5,
wherein the second thread allocates the frames to the biometric thread pool by:
obtaining a predetermined number of frames with the most recent timestamps from the given expiring buffer;
sorting the predetermined number of frames based on the included quality scores; and
allocating the sorted predetermined number of frames to each biometric subthread of the biometric thread pool.

7. The method of claim 1,
wherein the biometric thread pool comprises:
a first biometric subthread for a facial recognition algorithm that outputs a facial recognition result; and
a second biometric subthread for a liveness detection algorithm that outputs a liveness result,
wherein determining the workflow based on the biometric results includes:
creating a visitation event object including the facial recognition result and the liveness result;
correlating the facial recognition result with a database;
generating the command with an authorized control action based on a successful correlation of the facial recognition result with the database and a successful liveness result; and
generating the command with an unauthorized control action based on a failure to correlate the facial recognition result with the database or a failed liveness result.

8. A system for management of a visitor workflow, the system comprising:
a camera that generates a video stream; and
a processor configured to:
receive the video stream from the camera;
in a first thread, generate one or more expiring buffers by:
processing frames of the video stream;
using an object recognition algorithm to detect and track each face in the frames of the video stream and assign a universal unique identifier (UUID) for each face; and
maintaining, for each UUID, a corresponding expiring buffer that includes a timer and the frames of the video stream showing the face corresponding to the UUID;
in a second thread, process a given expiring buffer by:
obtaining a biometric algorithm list;
allocating frames of the given expiring buffer to a biometric thread pool comprising a biometric subthread for each algorithm of the biometric algorithm list;
executing the biometric thread pool in parallel;
harvesting biometric results from the biometric thread pool;
determining a workflow based on the biometric results; and
transmitting a command based on the workflow;
wherein the processor is configured to execute the first thread and the second thread at least partially in parallel.

9. The system of claim 8,
wherein the processor is configured to, in the first thread, maintain each corresponding expiring buffer by executing a maximum frame threshold comparison to determine whether or not to add a new frame to the corresponding expiring buffer,
wherein the maximum frame threshold comparison includes comparing a total number of frames in the corresponding expiring buffer to a predetermined maximum size,
in response to determining that the total number of frames in the corresponding expiring buffer is less than the predetermined maximum size, the new frame is added to the corresponding expiring buffer, and
in response to determining that the total number of frames in the corresponding expiring buffer is greater than or equal to the predetermined maximum size, the new frame is not added to the corresponding expiring buffer.

10. The system of claim 8,
wherein the processor is configured to, in the first thread, maintain each corresponding expiring buffer by executing a first trigger comparison to determine whether or not to trigger the processing of the corresponding expiring buffer by the second thread,
wherein the first trigger comparison includes comparing a total number of frames in the corresponding expiring buffer to a predetermined maximum size,
in response to determining that the total number of frames in the expiring buffer is greater than or equal to the predetermined maximum size, the corresponding expiring buffer is processed by the second thread, and
in response to determining that the total number of frames in the corresponding expiring UUID buffer is less than the predetermined maximum size, the corresponding expiring buffer is not processed by the second thread.

11. The system of claim 8,
wherein the processor is configured to, in the first thread, maintain each corresponding expiring buffer by executing a second trigger comparison to determine whether or not to trigger the processing of the corresponding expiring buffer by the second thread,
wherein the second trigger comparison includes comparing the timer of the corresponding expiring buffer to an expiration threshold,
in response to determining that the timer of the corresponding expiring buffer is less than the expiration threshold, the corresponding expiring buffer is not processed by the second thread, and
in response to determining that the timer of the corresponding expiring buffer is greater than or equal to the expiration threshold, the first thread executes a third trigger comparison,
wherein the third trigger comparison includes comparing a total number of frames in the corresponding expiring buffer to a predetermined minimum size,
in response to determining that the total number of frames in the corresponding expiring buffer is greater than or equal to the predetermined minimum size, the corresponding expiring buffer is processed by the second thread, and
in response to determining that the total number of frames in the corresponding expiring buffer is less than the predetermined minimum size, the first thread resets the corresponding expiring buffer by deleting the frames of the corresponding expiring buffer and resetting the timer of the corresponding expiring buffer.

12. The system of claim 8,
wherein the object recognition algorithm of the first thread is configured to:
detect one or more faces in a new frame of the video stream; and
calculate a quality score for each face based on an image quality metric,
wherein the quality score and a timestamp are included with the new frame.

13. The system of claim 12,
wherein the processor is configured to, in the second thread, allocate the frames to the biometric thread pool by:
obtaining a predetermined number of frames with the most recent timestamps from the given expiring buffer;
sorting the predetermined number of frames based on the included quality scores; and
allocating the sorted predetermined number of frames to each biometric subthread of the biometric thread pool.

14. The system of claim 8,
wherein the biometric thread pool comprises:
a first biometric subthread for a facial recognition algorithm that outputs a facial recognition result; and
a second biometric subthread for a liveness detection algorithm that outputs a liveness result,
wherein the processor is configured to, in the second thread, determine the workflow based on the biometric results by:
creating a visitation event object including the facial recognition result and the liveness result;
correlating the facial recognition result with a database;
generating the command with an authorized control action based on a successful correlation of the facial recognition result with the database and a successful liveness result; and
generating the command with an unauthorized control action based on a failure to correlate the facial recognition result with the database or a failed liveness result.

15. A non-transitory computer readable medium (CRM) storing computer readable program code for management of a visitor workflow, the computer readable program code causes a processor to:
receive a video stream from a camera;
in a first thread, generate one or more expiring buffers by:
processing frames of the video stream;
using an object recognition algorithm to detect and track each face in frames of the video stream and assign a universal unique identifier (UUID) for each face; and
maintaining, for each UUID, a corresponding expiring buffer that includes a timer and the frames of the video stream showing the face corresponding to the UUID;
in a second thread, process a given expiring buffer by:
obtaining a biometric algorithm list;
allocating frames of the given expiring buffer to a biometric thread pool comprising a biometric subthread for each algorithm of the biometric algorithm list;
executing the biometric thread pool in parallel;
harvesting biometric results from the biometric thread pool;
determining a workflow based on the biometric results; and
transmitting a command based on the workflow;
wherein the processor is configured to execute the first thread and the second thread at least partially in parallel.

16. The non-transitory CRM of claim 15,
wherein the processor is configured to, in the first thread, maintain each corresponding expiring buffer by executing a maximum frame threshold comparison to determine whether or not to add a new frame to the corresponding expiring buffer,
wherein the maximum frame threshold comparison includes comparing a total number of frames in the corresponding expiring buffer to a predetermined maximum size,
in response to determining that the total number of frames in the corresponding expiring buffer is less than the predetermined maximum size, the new frame is added to the corresponding expiring buffer, and
in response to determining that the total number of frames in the corresponding expiring buffer is greater than or equal to the predetermined maximum size, the new frame is not added to the corresponding expiring buffer.

17. The non-transitory CRM of claim 15,
wherein the processor is configured to, in the first thread, maintain each corresponding expiring buffer by executing a first trigger comparison to determine whether or not to trigger the processing of the corresponding expiring buffer by the second thread,
wherein the first trigger comparison includes comparing a total number of frames in the corresponding expiring buffer to a predetermined maximum size,
in response to determining that the total number of frames in the expiring buffer is greater than or equal to the predetermined maximum size, the corresponding expiring buffer is processed by the second thread, and
in response to determining that the total number of frames in the corresponding expiring UUID buffer is less than the predetermined maximum size, the corresponding expiring buffer is not processed by the second thread.

18. The non-transitory CRM of claim 15,
wherein the processor is configured to, in the first thread, maintain each corresponding expiring buffer by executing a second trigger comparison to determine whether or not to trigger the processing of the corresponding expiring buffer by the second thread,
wherein the second trigger comparison includes comparing the timer of the corresponding expiring buffer to an expiration threshold,
in response to determining that the timer of the corresponding expiring buffer is less than the expiration threshold, the corresponding expiring buffer is not processed by the second thread, and p2 in response to determining that the timer of the corresponding expiring buffer is greater than or equal to the expiration threshold, the first thread executes a third trigger comparison,
wherein the third trigger comparison includes comparing a total number of frames in the corresponding expiring buffer to a predetermined minimum size,
in response to determining that the total number of frames in the corresponding expiring buffer is greater than or equal to the predetermined minimum size, the corresponding expiring buffer is processed by the second thread, and
in response to determining that the total number of frames in the corresponding expiring buffer is less than the predetermined minimum size, the first thread resets the corresponding expiring buffer by deleting the frames of the corresponding expiring buffer and resetting the timer of the corresponding expiring buffer.

19. The non-transitory CRM of claim 15,
wherein the object recognition algorithm of the first thread is configured to:
detect one or more faces in a new frame of the video stream; and
calculate a quality score for each face based on an image quality metric,
wherein the quality score and a timestamp are included with the new frame.

20. The non-transitory CRM of claim 19,
wherein the processor is configured to, in the second thread, allocate the frames to the biometric thread pool by:
obtaining a predetermined number of frames with the most recent timestamps from the given expiring buffer;
sorting the predetermined number of frames based on the included quality scores; and
allocating the sorted predetermined number of frames to each biometric subthread of the biometric thread pool.
